(19) United States
(12) Patent Application Publication
(10) Pub. No.: US 2026/0125122 A1
(43) Pub. Date: May 7, 2026

(54) Track Motion Limiting Device

(71) Applicant: SROOC Holdings, LLC, Waco, TX (US)

(72) Inventor: Jerrod Chance Cook, Lorena, TX (US)

(21) Appl. No.: 19/360,971

(22) Filed: Oct. 16, 2025

Related U.S. Application Data
(60) Provisional application No. 63/708,104, filed on Oct. 16, 2024.

(51) Int. Cl. B62D 55/18

(52) U.S. Cl. CPC B62D 55/18

(57) ABSTRACT

A device for immobilizing a tracked vehicle includes a portion below the track secured to a potion above the track. If the vehicle is moved, the portion below the track will prevent the track from passing over the sprocket gear or a idler wheel, thereby limiting motion of the tracked vehicle.

### TECHNICAL FIELD OF THE INVENTION

The present invention relates to devices for limiting the motion of tracked vehicles and, in particular, to a track motion limiting device that is attached to a track to prevent it from traversing a sprocket.

### BACKGROUND OF THE INVENTION

Some vehicles, particularly those involved in moving heavy loads over unstable surfaces and those used in excavation, use tracks instead of tires. Tracks provide a large surface area in contact with the ground to distribute the vehicle weight over a wide. Tracks may be formed as a continuous band or as linked plates. A vehicle engine drives a sprocket gear that engages with regularly spaced holes in the track to drive the track and undriven idler wheels that guide the track. Tracked vehicles include, for example, excavators, bull dozers, loaders, and tractors. Such vehicles are often left at construction sites and can be stolen. Various means have been used to prevent theft, such as joystick steering locks and GPS trackers.

U.S. Pat. No. 11,794,829 to Burden, Jr. for a “Guarded Track Lock for Power-operated Machinery and Associated Methods” describes a mechanical lock that engages with the sprocket to prevent it from engaging with, and turning, a track.

U.S. Pat. No. 5,794,462 describes a U-shaped lock, in which the U has apertures on both ends. The bottom of the “U” is positioned at a side of the track and the two arms of the “U” extend above and below the track. A pin is inserted through apertures in the arms of the “U” and extends through a sprocket hole in the track. The “U” must be sufficiently long to extend from the sprocket hole to the edge of the track and so different locks will be preferred for different track widths.

U.S. Pat. No. 3,371,735 to Masera, et al. for a “Device for Locking Tracked Vehicles, in Particular Excavators and the Like” describes a locking device that immobilizes a track, not for the prevention of theft, but to prevent unintentional movement during operation, for example, under stress exerted by a heavy bucket. The system uses a slidable gear that meshes with the drive sprocket gear teeth to prevent the track from moving. Such a slidable gear requires a power source to move the gear and therefore adds complexity and expense.

U.S. Pat. No. 9,393,895 describes a method for securing objects, such as passenger seats and wheelchair restraints, to a logistic track secured to the floor of a vehicle.

Several devices have been used to lock a trailer hitch to prevent theft of a trailer including U.S. Pat. No. 6,786,068 to Spooner for a “Locking Device for Pintle Type Trailer Hitch;” U.S. Pat. No. 6,467,317 to Hillabush, et al, for a “Lunette Trailer Hitch Lock;” U.S. Des. Pat. No. 312,958 to Aguilar for a “Lunette Trailer Hitch Anti-Theft Device;” and U.S. Pat. No. 11,912,081 to Glenn for a “Mean Dog Trailer Theft Defender Lunette Lock.”

### SUMMARY OF THE INVENTION

An object of the invention is to provide a method and apparatus for immobilizing a tracked vehicle.

A tracked vehicle locking device includes two portions, one portion secured on each side of a track, and a lock that prevents the separation of the two portions without a key. The device prevents the track from rotating past the sprocket or idler wheels, thereby immobilizing the track vehicle.

The foregoing has outlined rather broadly the features and technical advantages of the present invention in order that the detailed description of the invention that follows may be better understood. Additional features and advantages of the invention will be described hereinafter. It should be appreciated by those skilled in the art that the conception and specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more thorough understanding of the present invention, and advantages thereof, reference is now made to the following descriptions taken in conjunction with the accompanying drawings, in which:

FIG. 1 shows a track locking device;

FIG. 2A shows an exploded view of the track locking device of FIG. 1 in relation to a track onto which the device is being installed;

FIG. 2B shows the device of FIG. 1 installed on a track;

FIG. 3 shows a lock plate of the track locking device of FIG. 1;

FIG. 4A shows a top isometric view of a lock of the track locking device of FIG. 1;

FIG. 4B shows a bottom isometric view of a lock of the track locking device of FIG. 1;

FIG. 5 shows a tumbler assembly for the track locking device of FIG. 1;

FIG. 6 shows a striker plate of the track locking device of FIG. 1;

FIG. 7 shows an exploded view of the striker plate assembly including, the striker plate, the striker reinforcement plate, and the wedge of the track locking device of FIG. 1;

FIG. 8 shows the wedge of the track locking device of FIG. 1;

FIG. 9 shows the track locking device of FIG. 1 installed on a tracked vehicle on a first side of the sprocket;

FIG. 10 shows the track locking device of FIG. 1 installed on a tracked vehicle on the opposite side of the sprocket from the first side in FIG. 9;

FIG. 11 shows two track locking devices of FIG. 1 installed on a tracked vehicle, one on each side of the sprocket;

FIG. 12 shows an enlarged view of the track locking device of FIG. 1 engaged with a sprocket from clockwise track motion;

FIG. 13 shows an enlarged view of the track locking device of FIG. 1 engaged with a sprocket from counterclockwise track motion;

FIG. 14 shows another embodiment of a track locking device;

FIG. 15 shows another embodiment of a track locking device;

FIG. 16A shows an exploded view of the track locking device of FIG. 15 in relation to a track onto which the device is being installed;

FIG. 16B shows the device of FIG. 15 installed on a track;

FIG. 17 shows a bottom isometric view of a lock of the track locking device of FIG. 15;

FIG. 18 shows the upper top plate of the track locking device of FIG. 15;

FIG. 19 shows the lower top plate of the track locking device of FIG. 15;

FIG. 20 shows a lock cap of the track locking device of FIG. 15; and

FIG. 21 shows another embodiment of a track locking device.

### DETAILED DESCRIPTION OF PREFERRED EMBODIMENTS

“Immobilizing a vehicle” as used herein means limiting the motion of the vehicle such that the track cannot complete a full rotation. The vehicle may be able to move a short distance in either direction before the locking device engages the sprocket or idle wheel and stops the vehicle motion.

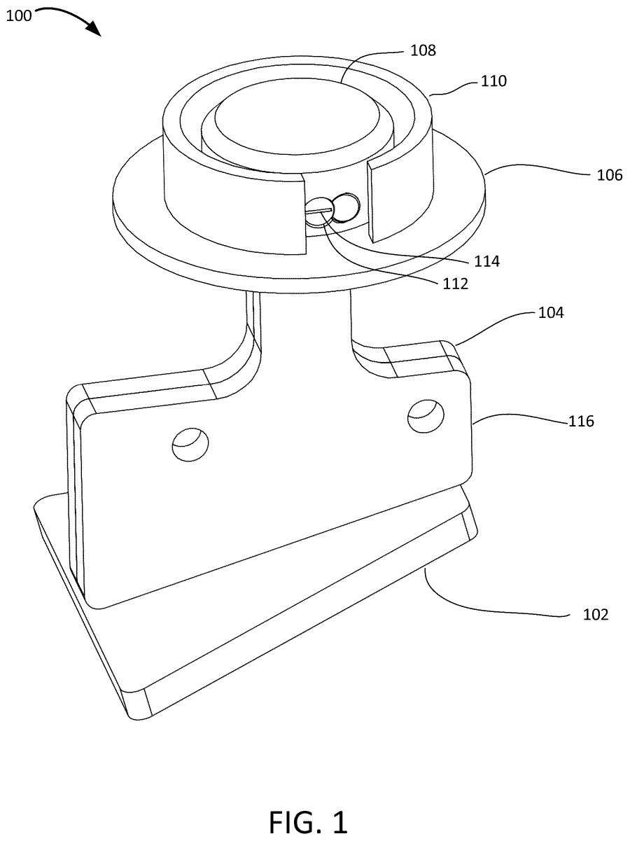

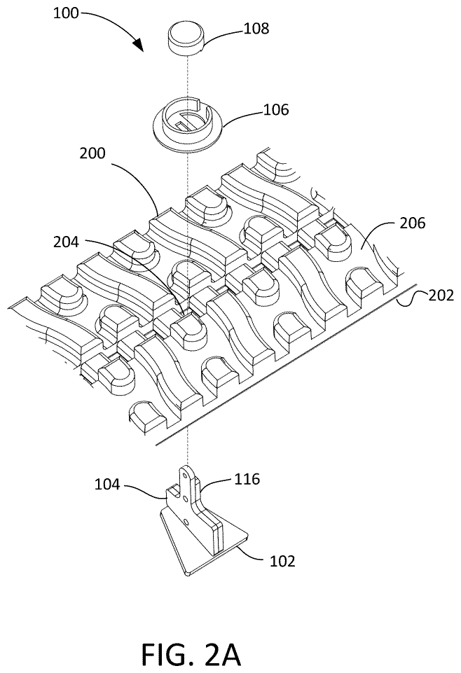

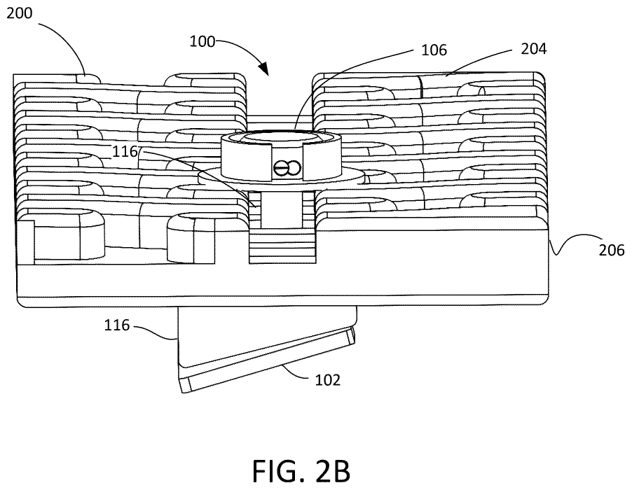

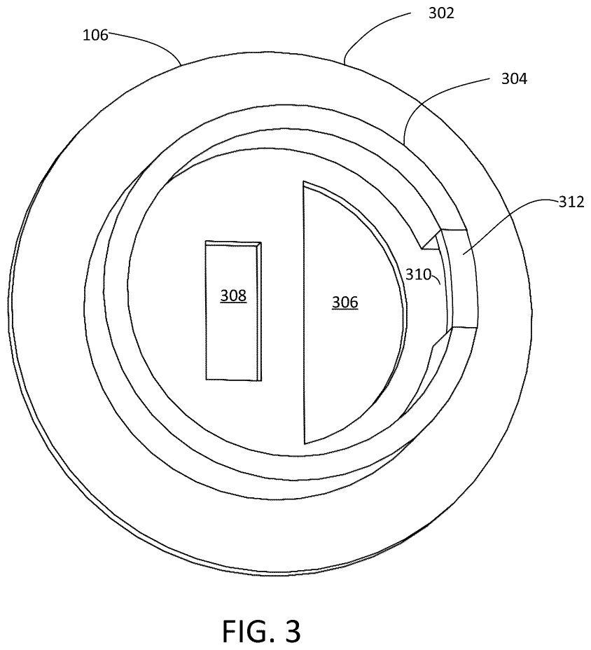

FIG. 1 shows an embodiment of a track locking device 100. FIGS. 2A and 2B show how the track locking device 100 is assembled onto a track 200, with FIG. 2A showing an exploded view of the parts prior to attaching to track 200 and FIG. 2B showing the track locking device 100 installed in track 200. Track locking device 100 includes a wedge 102 attached to a striker plate 104 which is designed to extend from a first side 202 of track 200, through a sprocket hole 204 in track 200, and into a lock base 106 on the opposite side 206 of the track 200. FIG. 3 shows an enlarged view of lock base 106. FIG. 3 shows lock base 106 includes a planar portion 302 and an incomplete annular portion 304 having a gap 310. Planar portion 302 includes a rectangular hole 308 through which striker plate 104 extends and a second hole 306 shaped as a truncated circle.

A lock 108 includes an opening for inserting a tumbler assembly 112 having a keyhole 114 for accepting a key (not shown) to rotate the tumbler and secure the lock 112 onto the striker plate 104. An optional striker plate support 116 provides additional mechanical strength to reinforce the striker plate 104. As shown in FIGS. 2A and 2B, striker plate 104 and striker plate support 116 extend though a sprocket hole 204 in track 200 while wedge 102 remains below track 200. Lock base 106 is positioned above the track such that striker plate 104 extends through hole 308 in lock base 106 and is secured by tumbler assembly 112.

As shown in FIG. 2B, the planar portion 302 of lock base 106 rests on track 200 and striker plate 104 with striker plate strengthener 116 extends from side 202 underneath the tract, through a sprocket hole 204 in track 200. Striker plate 104 extends into hole 308 of lock base 106. Lock 108 is then positioned within the annular portion 304 of lock base 106. Annular portion 304 provides additional resistance to tampering with lock 108. In some embodiments, a bridge extends over the gap in annular portion 304 to provide additional strength. Lock 108 can be inserted into lock base 110 past the bridge when tumbler assembly 112 is retracted into lock 108. Tumbler assembly 112 is positioned in lock 108 and can secure striker plate 104 in place.

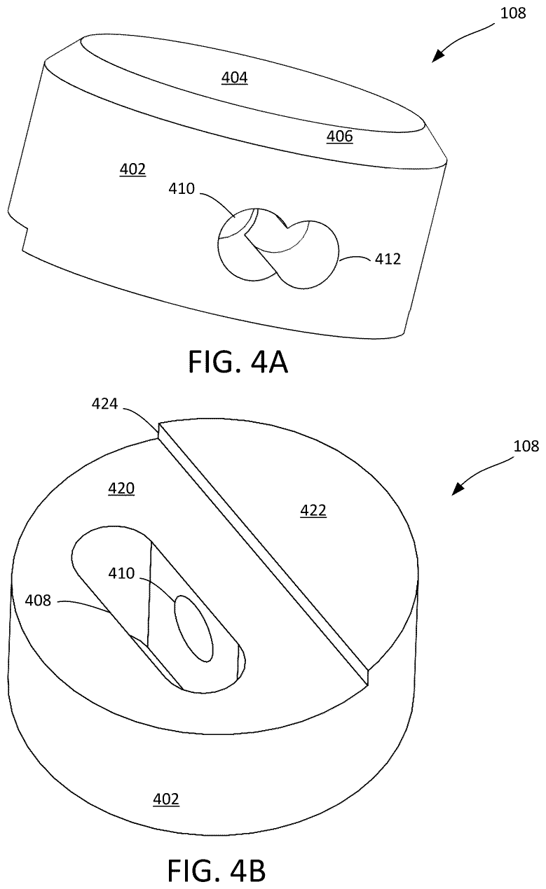

FIG. 4A shows a top size perspective view of lock 108 and FIG. 4B shows a bottom perspective view of lock 108. FIG. 4A shows that lock 108 has an annular side 402, a flat top 404 with a chamfered edge 406, and a blind hole 408 having two parallel edges connected by semicircular ends. A hole 410 extends from annular side 402 into hole 408 and a blind hole 412 in annular side 402 partially overlaps hole 410. FIG. 4B shows an optional two-level bottom surface includes a major bottom portion 420 and a stepped bottom portion 422, separated by a step 424. Stepped bottom portion 422 mates with hole 306 in lock base 106. When tumbler 114 is engage in hole 606 of the striker, lock 108 is prevented from rotating, but stepped bottom portion 422 mating with hole 306 provides additional strength to the device by further resisting rotation of lock 108. Some embodiments lack hole 306 in lock base 106 and do not have a two level surface in lock base 106.

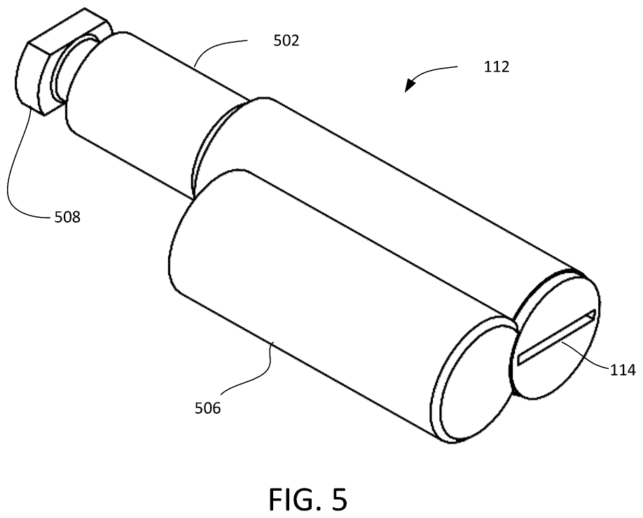

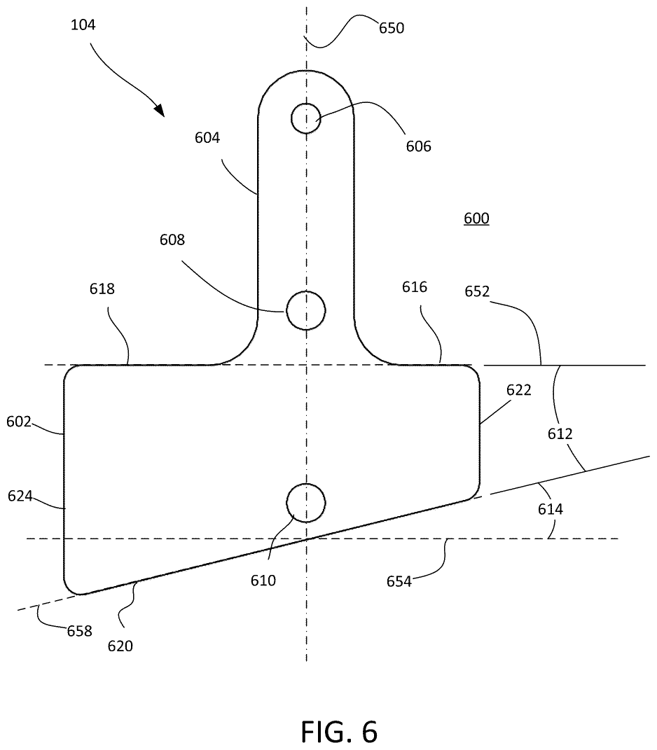

FIG. 5 shows tumbler assembly 112 comprises a tumbler cylinder 502 including keyhole 114, a stabilizing cylinder 506, and a tab 508. Tumbler cylinder 502 and stabilizing cylinder 506 can move back and forth in holes 410 and 412. In a locked configuration, tumbler cylinder 502 protruding through a hole 606 (FIG. 6) in striker plate 104 to secure the locking device to 100 to track 200. In some embodiments, the lock is configured that a key is required both to lock and to unlock the track locking device 100 so that the device cannot be inadvertently locked when the key is not available. Multiple track locking devices 100 can be keyed alike to that one key can lock and unlock the devices on multiple different tracked vehicles.

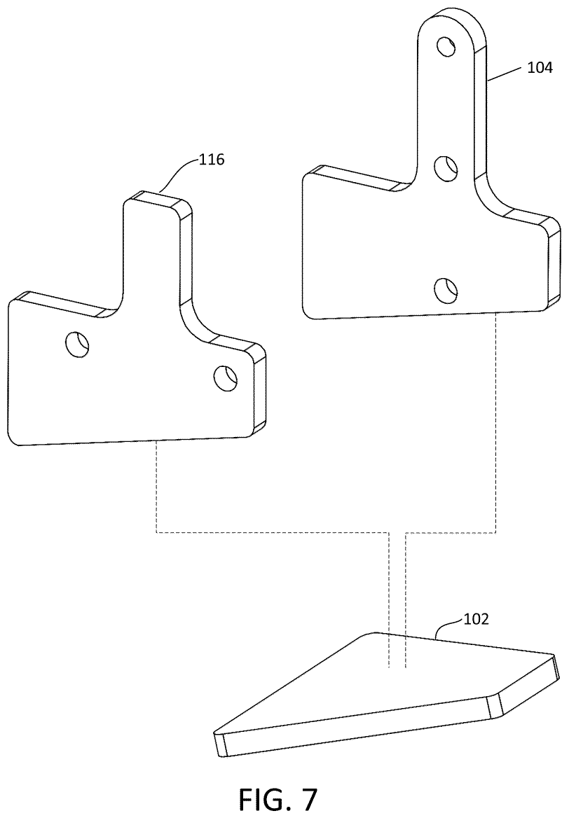

FIG. 6 shows that striker plate 104 includes a lower portion 602 to which wedge 102 (not shown in FIG. 6) is attached and an upper portion 604. Hole 606 in upper portion 604 accommodates a portion of the tumbler assembly that passes into hole 606 to secure the track lock 100 onto track 200. Hole 608 and optional 610 facilitate striker plate reinforcer 116 to striker plate 104. FIG. 7 shows how striker plate 104, striker plate reinforcer 116, and wedge 102 are assembled. Striker plate 104, striker plate reinforcer 116, and wedge 102 can be formed, for example, from ½ inch steel plate and are welded together. All steel components are preferably powder coated to improve corrosion resistance. Alternatively, striker plate 104 and striker plate support 116, or striker plate 104, striker plate support 116, and wedge 102 can be formed integrally as a single part, such as by casting.

The lower portion 602 is wider than the upper portion 602. The change in width between the lower portion 602 and the upper portion 604 forms a shoulder 616 and a shoulder 618 at the upper edges of lower portion 602. Lower portion 602 includes a bottom edge 620 to which wedge 102 (not shown) is attached. Because edge 622 and edge 625 are not the same distance from axis 650, shoulder 616 and 618 are not of equal lengths. For example, should 618 may be an inch longer than shoulder 616. This asymmetry is thought to assist in jamming device 100 into the sprocket or idler wheel of the vehicle on which the device is mounted and also facilitates mounting the device 100 onto a vehicle.

To more clearly describe the geometry of the striker plate 104, the geometry will be described as if the striker is a two-dimensional object, and the thickness will be ignored. In such a representation, the striker plate 104 s contained within a striker plate plane 600. FIG. 6 shows a centerline 650 of upper portion 604. The shoulders 616 and 618 define a line 652 that is perpendicular to center line 650. A line 654 is also perpendicular to center line 650 and passes through the point where the center line 650 intersects the bottom edge 620 of the lower portion 602. A line 658 runs along the lower edge 620 of lower portion 602. The angle 614 between line 658 and line 654 is preferably between about 0 degrees and 45 degrees, more preferably between about 5 degrees and 25 degrees, and even more preferably about 15 degrees. In embodiments where the shoulders 616 and 618 are perpendicular to the centerline 650, angle 612 is the same as angle 614.

Because wedge 102 is attached to bottom surface 620, the angle of the plane of wedge 102 relative to a plane perpendicular to the striker plate plane 600 and containing line 654 is the same as angle 614.

The angle of wedge 102, which is determined by the angle 614 of the bottom edge 620 of the striker plate, assists the locking device 100 to engage with the drive sprocket if someone tries to move the vehicle while the locking device is attached. The angle is also thought in some vehicles to facilitate immobilizing the vehicle by derailing of the track when the device is forced against a sprocket or idler wheel. The device can limit the motion of the vehicle either by jamming at the sprocket or idler wheel, or by derailing the track. The angle also makes it easier for a user to fit the device onto the vehicle under the track. Angle 614 can be zero, although non-zero angle has the advantages described above. While the geometry of the striker plat and the wedge may provide various advantages for locking different vehicles, the geometry can vary considerably, and the invention is not limited by the geometry. For example, shoulder 616 and 618 may have equal lengths, the angle 614 may be zero.

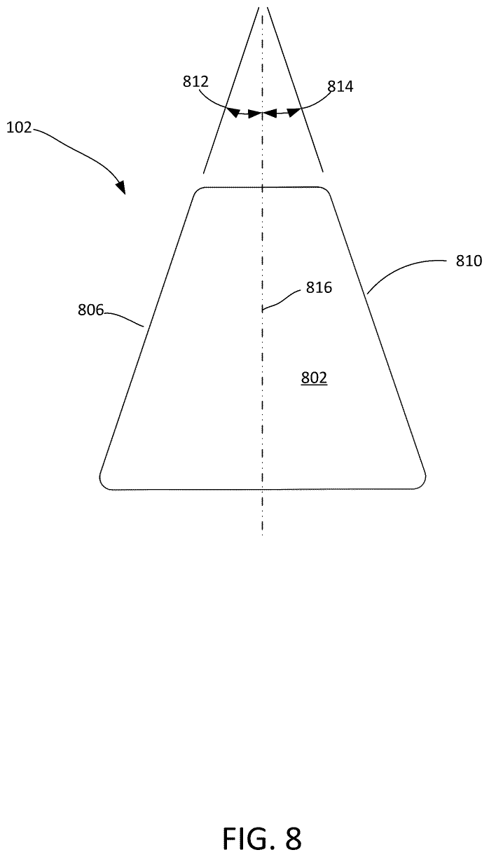

FIG. 8 shows wedge 102 in the shape of an isosceles trapezoid 802. The two long edges 806 and 810 make angles 812 and 814 with a centerline 816. In one embodiment, angles 812 and 814 are equal and between about 5 degrees and 30 degrees, between about 10 degrees and 25 degrees, or about 19 degrees. While wedge 102 is an isosceles trapezoid in one embodiment, the shape can vary and does not need to be an isosceles trapezoid or a trapezoid at all. Sides 806 and 810 do not need to be of equal length and angles 812 and 814 do not need to be equal. Wedge 102 does not need to be flat and can be, for example, V-shaped. The trapezoidal shape is thought, on some tracked vehicles, to facilitate the derailing of the track when the device is forced against a sprocket or idler wheel. The locking device can limit the motion of the vehicle either by jamming at the sprocket or idler wheel, or by derailing the track. The trapezoidal shape also makes it easier for a user to fit the device under the track, particularly when the narrow end is oriented towards the vehicle. In some embodiments, the wedge can be dispensed with and the striker plate alone can immobilize the vehicle.

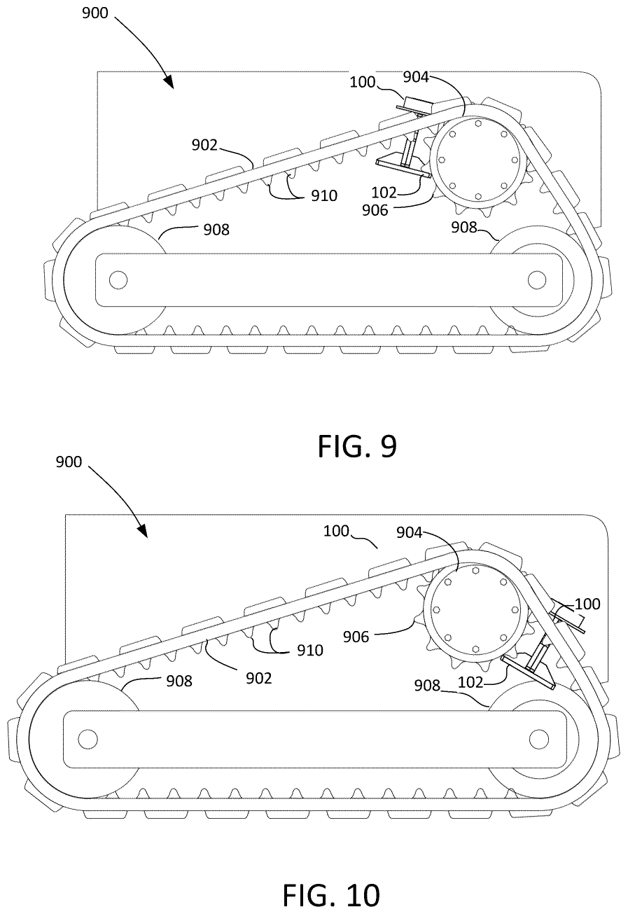

FIG. 9 shows a tracked vehicle 900 having a track 902, a sprocket 904 having multiple teeth 906, and two idler wheels 908. Track 902 includes ridges 910 on the inside portion. A locking device 100 is attached to track 902 with the narrow edge of the wedge facing towards the vehicle 900 and the wide side towards the outside of the vehicle. FIG. 9 shows one edge of wedge 102 of the locking device 100 engaging with one of the teeth 906 of the sprocket 904. The opposite edge of wedge 102 may engage with ridges 910 of track 902. Embodiments of device 100 described engage the sprocket, causing the track and sprocket to stop moving or possibly to derail. In FIG. 9, the device is shown as the track is moved clockwise.

FIG. 10 is similar to FIG. 9, but the track locking device is mounted on the opposite side of sprocket 904 and the track 902 is moving counterclockwise.

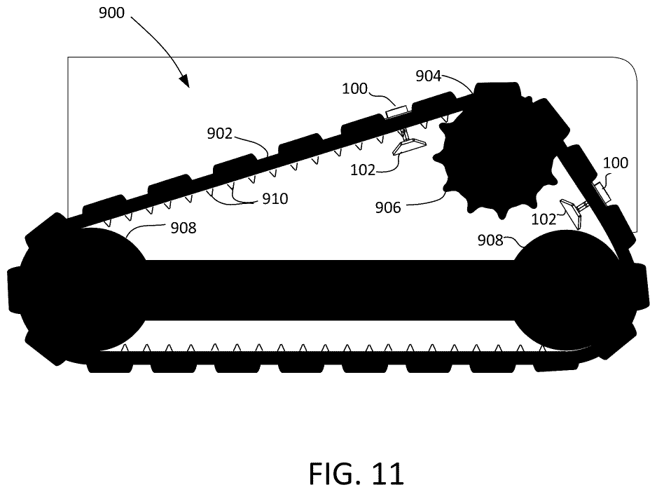

In the configurations shown in FIGS. 9 and 10, the distance that the track can move before the track is immobilized will depend on the direction of motion of the track. Moreover, in one direction, the wedge 102 will wedge between sprocket 904 and the track 902, whereas motion in the other direction will result in the wedge 102 wedging between the track 902 and one of idler wheels 908. FIG. 11 is similar to FIGS. 9 and 10 but FIG. 11 includes two track locking devices 100. By using two track locking devices 100, one on either side of the sprocket 904, the locking devices can be positioned so that the wedge of one locking device or the other will wedge between the sprocket and the track, regardless of which direction the track moves. By using two locking devices, one positioned on either side of the sprocket, attempting to rotate the track in either direction can lock the track sooner in either direction. This configuration is preferable, and the locking devices can be sold in pairs.

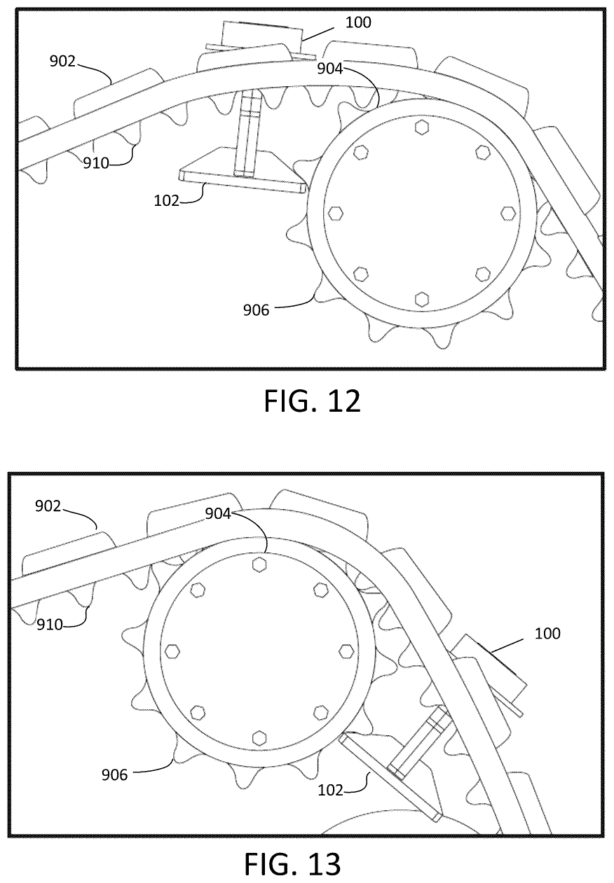

FIG. 12 shows how wedge 102 is trapped by the gears 906 of sprocket and track 902 when the track 902 and sprocket 904 are moving clockwise. FIG. 13 shows how wedge 102 is trapped by the gears 906 of sprocket and track 902 when the track 902 and sprocket 904 are moving counterclockwise.

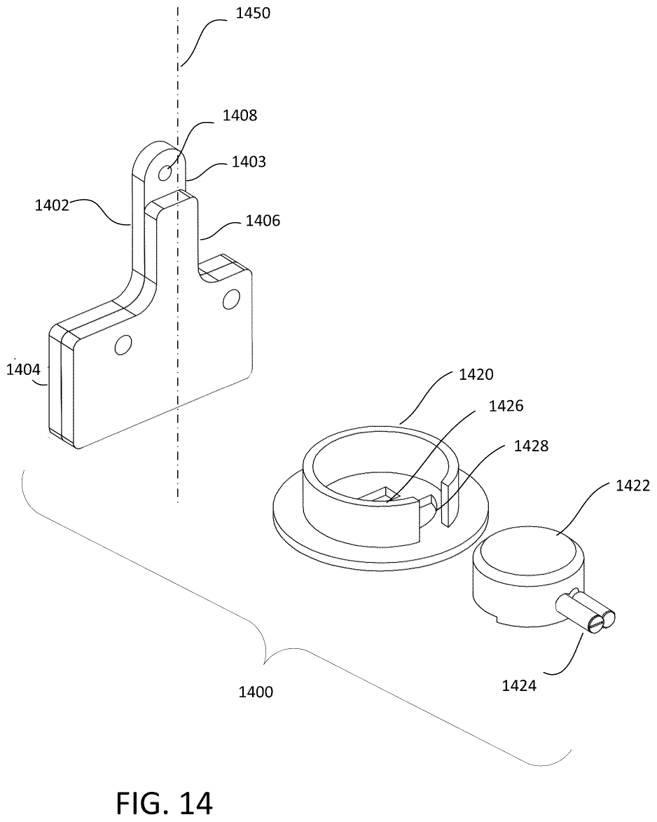

FIG. 14 shows the components of an alternative embodiment of a track locking device 1400. Track locking device 1400 includes a striker plate 1402 having an upper portion 1403 and a lower portion 1404, with a hole 1408 in upper portion 1403. An optional striker plate support 1406 provides additional strength to track plate 1402. Track locking device 1400 includes a lock plate 1420 having holes 1426 and 1428 and a lock 1422 having a tumbler assembly 1424, shown in the outward, unlocked, position. As with device 100, striker plate 1402 is inserted from below a track and lock plate 1420 is positioned on the top of the track such that the thin portion 1414 of striker plate 1402 extends through hole 1426 in lock plate 1420. Striker plate support 1405 does not extend through hole 1426.

Immobilization device 1400 differs from track locking device 100 primarily in that the bottom of striker plate 1402 is approximately perpendicular to a center line 1450 and immobilization device 1400 does not include a wedge attached to the bottom of the striker plate. Other details can be same as in locking device 100.

The striker plate and/or the wedge are not limited to any particular shape.

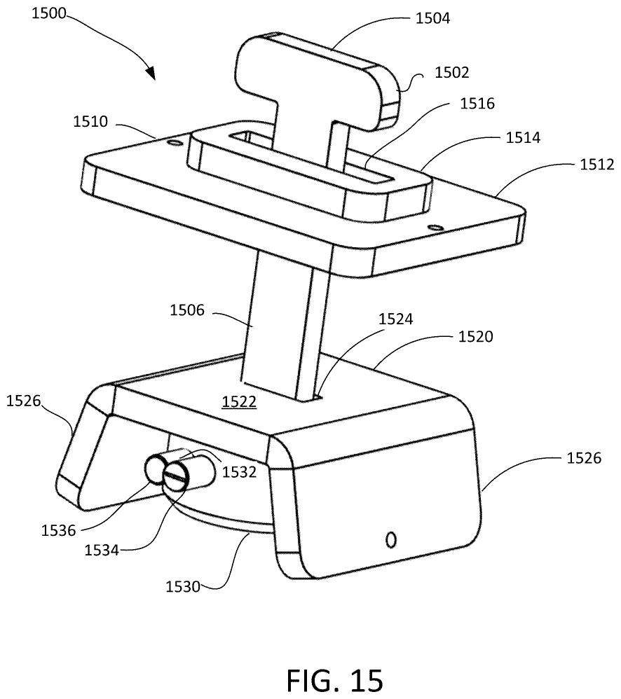

FIG. 15 shows an immobilization device 1500 that is suitable for use on smaller tracked vehicles, such as the Bobcat MT100. Immobilization device 1500 includes a striker 1502 having a handle portion 1504 and a straight portion 1506. A top plate 1510 includes a lower top plate 1512 and an upper top plate 1514 that are permanently joined to form a single unit and includes a rectangular aperture 1516 in upper top plate 1514 sized to accommodate handle portion 1502 of striker 1502. A smaller aperture 1902 (FIG. 19) in lower top plate 1512 is sized to allow straight portion 1506 to pass through it but to block passage of handle portion 1504 of striker 1502.

A lock cap 1520 includes a central portion 1522 having a rectangular aperture 1524 sized to accommodate the straight portion 1506 of the striker 1502 and two opposing angled portions 1526. A lock 1530 can be similar to the lock 108 of FIG. 1 and includes a tumbler assembly 1532 that includes a tumbler cylinder 1534 and a stabilizing cylinder 1536. Lock 1530 can have a flat bottom and lack the stepped bottom portion of the lock 108 of FIG. 3.

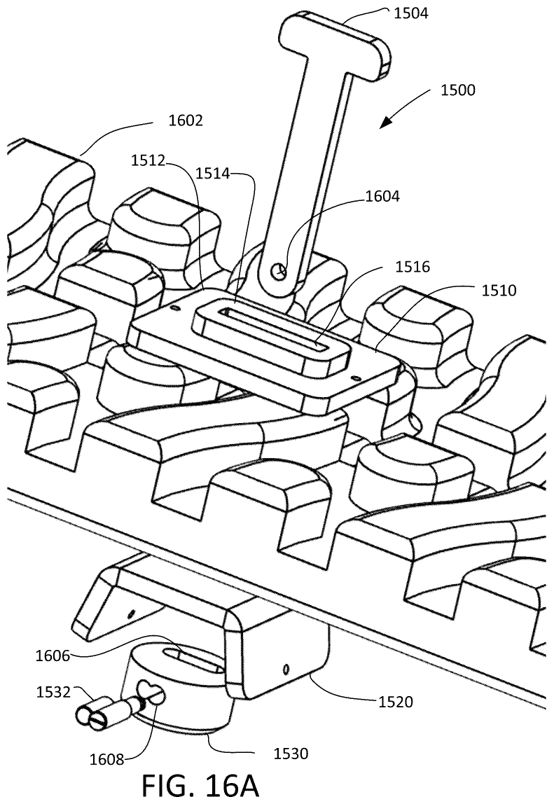

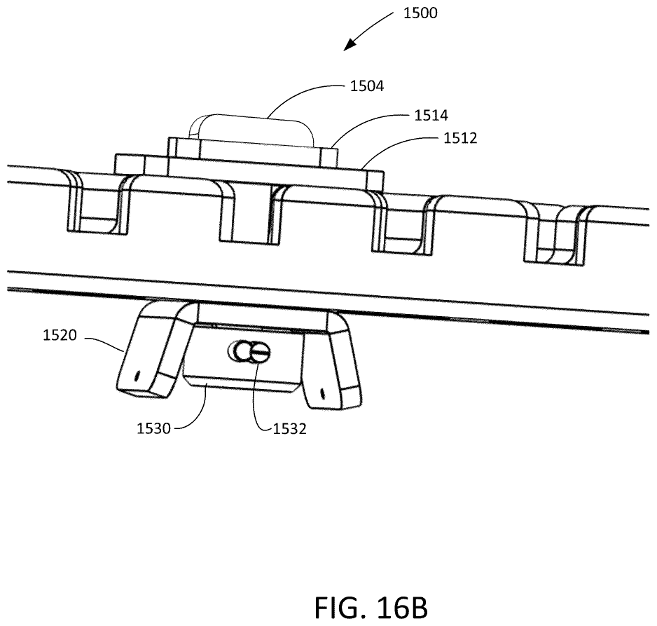

FIG. 16A is an exploded view showing how immobilization device 1500 is attached to a track 1602. Top plate 1510 is positioned on the top of the track 1602 and the straight portion 1506 of striker 1502 is inserted through the aperture 1516 and through a sprocket hole 204 (not visible) in track 1602. Lock cap 1520 is positioned under track 1602 with straight portion 1506 passing through aperture 1524. Lock 1530 is positioned below lock cap 1520 with straight portion 1506 extending into an aperture 1606 opening at the top of lock 1530. A key (not shown) is turned in tumbler assembly 1532 and tumbler cylinder 1534 extends through hole 1604 in straight portion, thereby locking the striker.

FIG. 16B shows immobilization device 1500 attached to track 1602. FIG. 16B shows that the handle portion 1504 of striker 1502 is partially inserted within aperture 1516 of upper plate 1514.

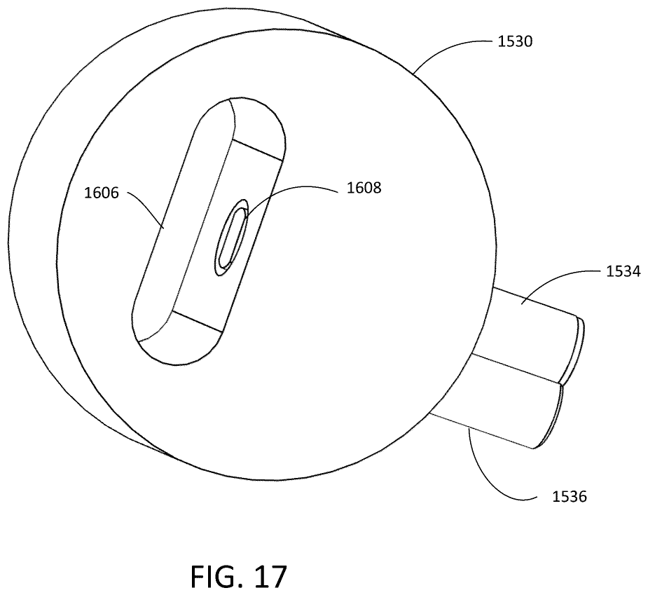

FIG. 17 shows lock 1530 with blind aperture 1706 for accepting straight portion 1506 of striker 1502 and showing the aperture 1708 through which tumbler cylinder 1532 extends to lock into hole 1704 of straight portion 1506. FIG. 17 shows lock 1530 in the open configuration with tumbler 1522 and stabilizing cylinder 1536 extended out of lock 1530.

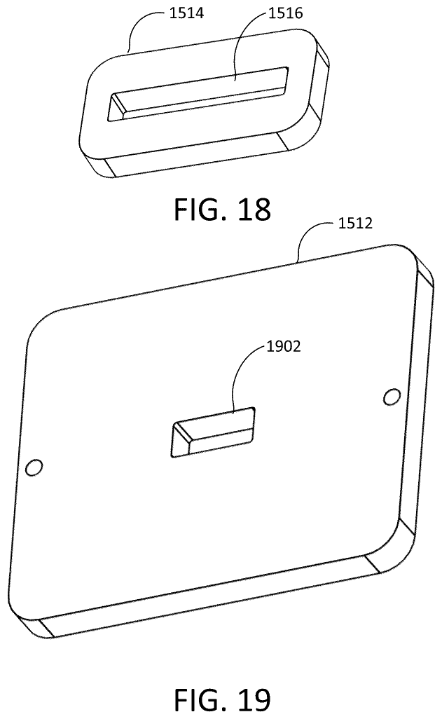

FIGS. 18 and 19 show the upper top plate 1514 and lower top plate 1512, respectively. Aperture 1516 is longer than aperture 1524 so that straight potion 1506 will easily pass through both apertures, but handle portion 1504 cannot pass through aperture 1524. Aperture 1516 is sufficiently large that handle portion can fit into the aperture, which increases the strength of the installed locking device 1500. The height of the handle portion 1524 is typically greater than the thickness of the upper top plate 1514, and so part of handle portion will extend above the top surface of upper plate 1514 making it easy to grab.

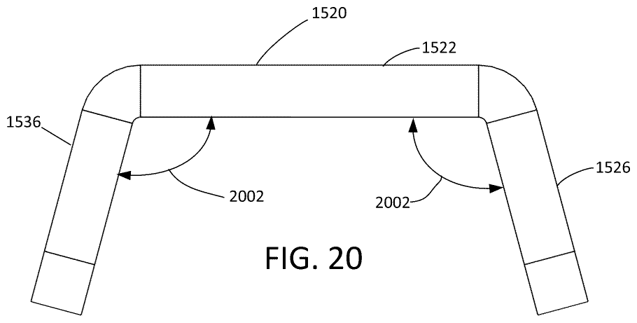

FIG. 20 shows lock cap 1520. The angle 2002 between center portion 1522 and angled sides 1526 is preferably between 90° degrees and 135° degrees, more preferably between 105° and 120° and in one embodiment, is example 105°. Applicant has found that an angle greater than 90 degrees facilitates installation. Skilled persons can determine an optimal angle 2002 for any particular vehicle through trial and error. Some tracked vehicles, such as excavators, are configured with less clearance below the track, so a locking device configuration as shown in FIG. 15, which extends less below the track, may be more compatible and easier to install than a device as shown in FIG. 1 or 14.

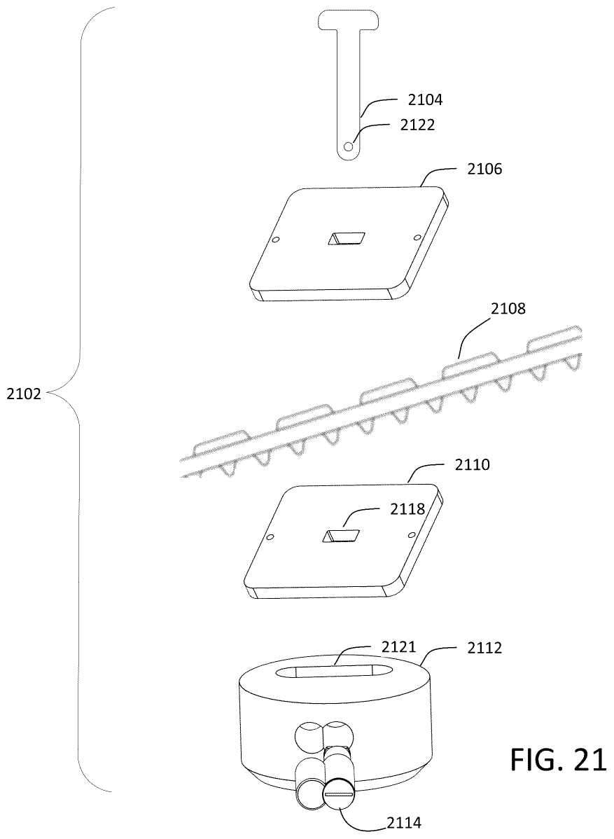

FIG. 21 shows a track locking device 2102 that includes a striker plate 2104, an optional top plate 2106 that rests above a rack 2108, an optional bottom plate 2110, and a lock 2110 having a tumbler 2114. A first portion of the striker plate 2104 is sufficiently narrow to extend through a sprocket hole in the track and a second portion of the striker plate is too large to fit through the sprocket hole and so stays on the top side of the track. To install track locking device 2102 onto a vehicle, striker plate 2104 is inserted through an aperture 2116 in optional top plate 2106, then through a sprocket hole (not shown) in track 2108, through an aperture 2118 in optional bottom plate 2110 and into an aperture 2121 in lock 2112. A tumbler cylinder 2114 can extend into lock 2112 to engage with a hole 2122 in striker plate 2104. A locking device includes a striker plate that extends partly through a sprocket hole in the track and a lock to secure the striker plate, with the striker plate, the lock, or a combination of the striker plate and the lock, being sufficiently large to stop the track from rotating over the sprocket or the idler wheel. A top plate can be used on top of the track to support the striker plate, or the striker plate can be made sufficiently robust that a top plate is not required and can rest directly on the track. Similarly, a bottom plate can be used below the track to support the lock, or the lock can be made sufficiently robust that a bottom plate is not required and the lock can rest directly on the bottom side of the track.

Unlike the U-shaped lock of U.S. Pat. No. 5,794,462, the devices described above do not encircle half the track and therefore can be used on tracks of any width. The devices described above are inserted in the center of the track through sprocket holes in the track without having to extend to the track edges. Thereby facilitating use of a mor compact device and allowing the device to be used on different tracks regardless of the track width.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

We claim as follows:

1. A locking device for immobilizing a tracked vehicle, comprising:
a striker plate including a first portion having a hole and a first width and a second portion having second width, larger than the first width, the top of the second portion forming a shoulder;
a lock base including a flat portion and a raised annular portion, the flat portion including an aperture sufficiently large to pass the first portion of the striker plate and sufficiently small to block the shoulder;
a wedge plate attached to a bottom edge of the second portion, the wedge plate extending away from the second portion of the striker plate;
a lock configured to be positioned within the annular portion of the lock base, the lock engaging the hole in the first portion striker plate secure the based plate to the striker plate.

2. The locking device of claim 1 in which the striker plate defines a striker plate longitudinal plane and the wedge plate defines a wedge plate longitudinal plane, and the striker plate longitudinal plane is substantially perpendicular to wedge plate longitudinal plane.

3. The locking device of claim 2 in which the shoulder of the striker plate defines a shoulder plane and in which the plane of the wedge is not parallel to the shoulder plane.

4. The locking device of claim 1 in which the wedge comprises a trapezoid and in which a line perpendicular to the two parallel sides of the trapezoid is parallel to the shoulder.

5. The locking device of claim 1 in which the lock includes two cylindrical holes configured for inserting the lock.

6. A method of immobilizing a tracked vehicle, comprising:
providing a locking device in accordance with claim 1;
inserting the first portion of the striker plate from a first side of a track of the tracked vehicle through a hole in a track of the tracked vehicle;
placing a base plate from the opposite side of the track such that the first portion of the striker plate extends through a hole in the base plate;
placing a lock housing onto the base plate;
placing a lock in the lock housing such that locking the lock causes a bolt to pass into a hole in the first portion of the striker plate.

7. A method of immobilizing a tracked vehicle, comprising:
providing a locking device including:
a striker plate having a first portion that fits through a hole in the track and a second portion that does not fit through the hole in the track;
a base plate too large to fit through the hole in the track and including a hole through which the first portion of the striker plate can pass;
a lock for securing the striker plate to the base plate, the method comprising:
inserting the first portion of the striker plate through the hole in the track from a first side of the track;
inserting the base plate onto the first portion of the striker plate from the opposite side of the track;
securing the base plate to the first portion of the striker plate using the lock,
the track being sandwiched between the second portion of the striker plate and the base plate.

8. The method of claim 7 in which inserting the first portion of the striker plate through the hole in the track from a first side of the track comprises inserting a striker plate having a wedge attached to the second portion, such that as the locking device attached to the track approaches the sprocket, the wedge will be trapped between the track and the sprocket and cause the track to move away from the sprocket.

9. The method of claim 8 in which the wedge comprises a trapezoidal-shaped plate.

10. The method of claim 9 in which the wedge includes a long side and a short side, a line between the long side and the short side being parallel to a major surface of the second portion of the striker plate.

11. The method of claim 7 in which the striker plate includes:
a major surface defining a striker plane;
a longitudinal centerline of the first portion and intersecting the bottom surface of the striker plate at an intersection point; and
a normal plane perpendicular to the striker plane and containing the intersection point;
and wherein the bottom surface of the second portion forms a non-zero angle with the normal plane.

12. (canceled)

13. (canceled)

14. (canceled)

15. (canceled)

16. (canceled)

17. A locking device for immobilizing a tracked vehicle having a track with sprocket holes for driving the track, comprising:
a striker plate including a first portion sufficiently small to pass through a sprocket hole in the track of the tracked vehicle and a second portion too large to pass through the sprocket hole in the tracked vehicle, the first portion including a hole; and
a lock having an aperture sized to accept the first portion of the striker plate and including a tumbler that, when in the locked position, extends through the hole in the first portion to secure the striker plate to the lock, such that the striker plate and/or the lock prevents the track from moving past a sprocket or an idler wheel.

18. The apparatus of claim 17 further comprising a lock plate having an aperture sized to pass the first portion of the striker plate, the lock plate configured to be positioned between the track and the lock.

19. The apparatus of claim 18 further comprising a first top plate having an aperture sized to pass the first portion of the striker plate but too small for the second portion of the striker plate to pass, the first top plate positioned on the opposite side of the track from the lock plate.

20. The apparatus of claim 19 further comprising a second top plate having a thickness and the second portion of the striker having a height, the second top plate being positioned above the first top plate and having an aperture sufficiently wide to fit the second portion of the striker plate, the thickness of the second top plate being less than the height of the second portion of the striker plate.

21. The apparatus of claim 19 in which the lock plate comprises a central portion in which the aperture is positioned and two angled portions, the lock plate configured to position the lock between the two angled portions.

22. The apparatus of claim 21 in which the angled portions are configured to obstruct movement of the track when the angled portion contacts the sprocket or an idle wheel.

23. The apparatus of claim 18 further comprising a wedge attached to the bottom of the second portion of the striker plate and in which the first portion of the striker plate extends through the track from below the track and passes through the lock plate and into the lock.

24. The apparatus of claim 23 in which the wedge has a trapezoidal shape.

25. The apparatus of claim 23 in which the bottom of the second portion of the striker plate is oriented at an angle other than ninety degrees relative to a vertical axis of the striker plate.

26. The apparatus of claim 18 in which the lock plate includes an annular portion having a gap, the lock positioned in the annular portion.
